(19) United States
(12) Patent Application Publication
(10) Pub. No.: US 2025/0039086 A1
(43) Pub. Date: Jan. 30, 2025

(54) PACKET ROUTING IN A SWITCH

(71) Applicant: Intel Corporation, Santa Clara, CA (US)

(72) Inventors: Mitu AGGARWAL, Portland, OR (US); Robert VALIQUETTE, Carignan (CA); Grzegorz NITKA, Gdansk (PL); Lukasz KUPCZAK, Kraków (PL)

(21) Appl. No.: 18/614,377

(22) Filed: Mar. 22, 2024

Related U.S. Application Data
(60) Provisional application No. 63/623,014, filed on Jan. 19, 2024.

(51) Int. Cl. H04L 45/74

(52) U.S. Cl. CPC H04L 45/74

(57) ABSTRACT

Examples described herein relate to a switch circuitry that includes an interface to a first ingress port; an interface to a second ingress port; and circuitry. In some examples, the circuitry is to associate the first ingress port with a first virtual function (VF); associate the second ingress port with a second VF; and based on a configuration and receipt of a first packet at the first ingress port, cause the first packet to be filtered, wherein the first packet is addressed to the second VF.

### RELATED APPLICATION

This application claims priority from U.S. Provisional Application No. 63/623,014, filed Jan. 19, 2024. The entire content of that application is incorporated by reference in its entirety.

### BACKGROUND

A datacenter can include multiple computing platforms communicatively coupled by network interface devices and switches. A switch can perform packet routing across virtual ports based on media access control (MAC) addresses. For ingress traffic to be terminated at the switch, a virtual function (VF) can receive traffic from its associated virtual port. For virtual machine-to-virtual machine (VM-to-VM) traffic, a VF can send traffic to another VF even if both VFs are associated with different virtual ports.

### BRIEF DESCRIPTION OF THE DRAWINGS

FIG. 1 depicts an example system.

FIG. 2 depicts an example initialization process for configuring forwarding rules.

FIG. 3 depicts a process.

FIG. 4 depicts an example network interface device.

FIGS. 5A-5C depict example switches.

FIG. 6 depicts an example system.

### DETAILED DESCRIPTION

In a configuration of a switch with virtualization enabled, a single physical function (PF) associated with the switch can be exposed across multiple physical ports and a single virtual ethernet bridge (VEB) or a switch identifier (ID) can be associated with a packet processing circuitry that performs the switching of packets across physical or logical ports of the switch. As such, a single switch ID instance may be used to represent a single PF across logical ports. Supporting multiple switch ID (e.g., one switch ID per port) may involve multiplying the number of forwarding rules by the number of ports and there may not be enough hardware resources (e.g., memory) to support storing the multiple rules.

In some examples, for a switch with multiple ports and there is one or more internal virtual Ethernet bridge (VEBs) or switch domain IDs that the VFs are attached to, the switch can direct packets to and from Virtual Functions (VFs) that are bound to specific logical ports. In some examples, the switch can be configured to perform rules to forward packets to a virtual machine (VM) and associated VF based on a logical port identifier value, destination media access control (MAC), Ethernet packet header field value, and/or virtual local area network (VLAN). For example, based on a configuration, the switch can apply receiving rules so that if a packet arrives at an expected or unexpected ingress port and has a destination port of destination MAC address of a particular VF, the packet can be switched to that particular VF. For example, if a destination media access control (MAC) address in a packet received on port X matches the MAC address of a virtual machine (VM)/VF pinned to the port X, the switch forwards the packet to the pinned VF even if the packet was received on port Y. A packet processing circuitry of the switch can be configured to direct packets to a VF based on an accept list per virtual or logical port that includes Virtual Station Interfaces (VSIs) and VFs associated with the virtual or logical port.

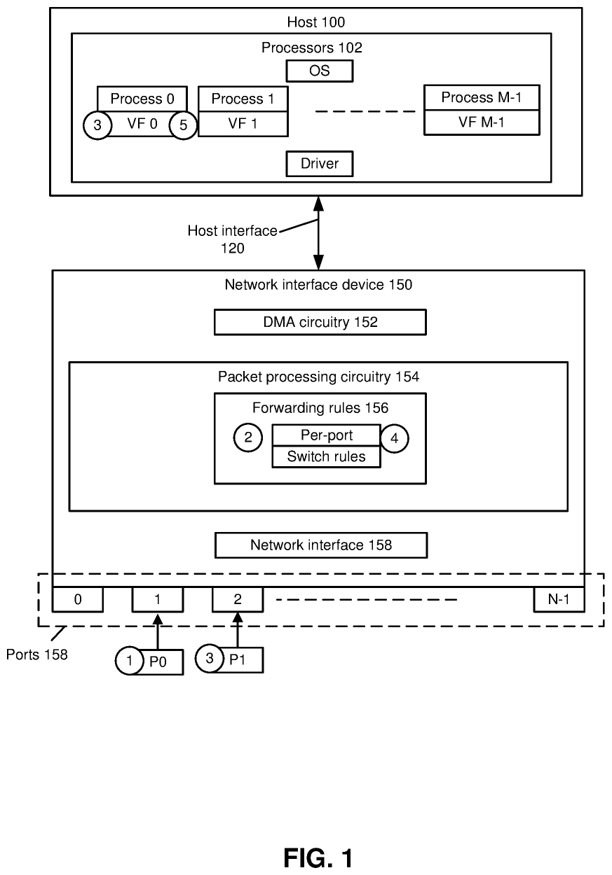

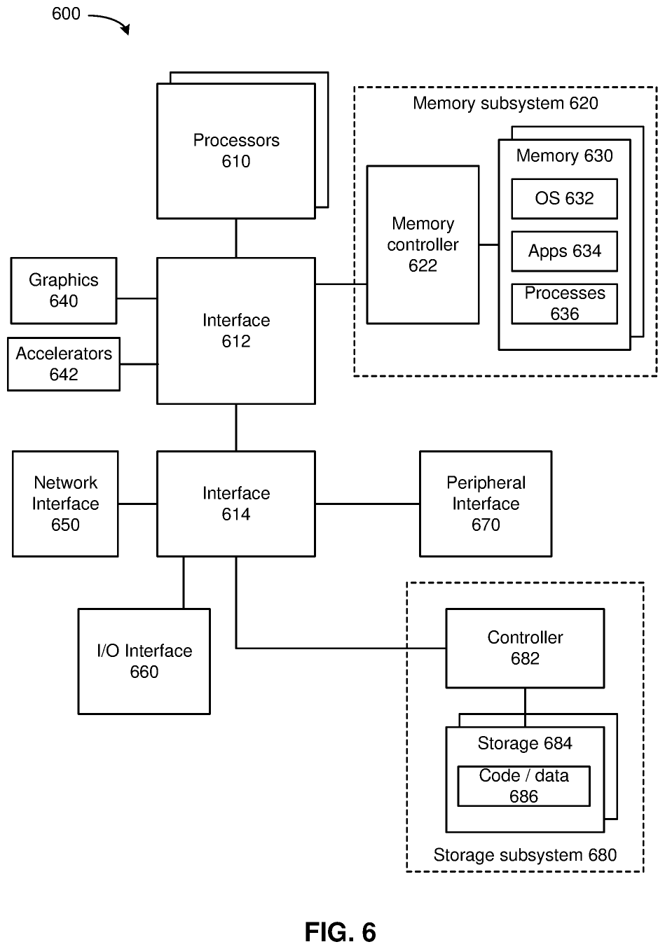

FIG. 1 depicts an example system. Host 100 can include circuitry and/or software described at least with respect to FIG. 6. Host 100 can include one or more processors 102 (e.g., a central processing unit (CPU); a programmable packet processing circuitry; an accelerator; an application specific integrated circuit (ASIC); a field programmable gate array (FPGA); a graphics processing unit (GPU); a memory device; or other circuitry). One or more processors 102 can execute one or more of processes 0 to M−1 (where M is an integer), a driver, and an operating system (OS). Processes 0 to M−1 can include one or more of: an application, a microservice, virtual machine (VM), microVM, container, thread, or other virtualized execution environment.

In some examples, processors 102 or other circuitry in host 100 can access network interface device 150 as one or more virtualized devices. For example, Single Root I/O Virtualization (SR-IOV) and Sharing specification, version 1.1, published Jan. 20, 2010 specifies hardware-assisted performance input/output (I/O) virtualization and sharing of devices. SR-IOV can provide a device partitioning to create multiple virtual functions (VFs) on a physical function (PF). Intel® Scalable I/O Virtualization (SIOV) permits configuration of a device to group its resources into multiple isolated Assignable Device Interfaces (ADIs). Direct Memory Access (DMA) transfers from/to an ADI are tagged with a unique Process Address Space identifier (PASID) number. SIOV enables software to flexibly compose virtual devices utilizing the hardware-assists for device sharing. An example technical specification for SIOV is Intel® Scalable I/O Virtualization Technical Specification, revision 1.0, June 2018, as well as earlier versions, later versions, and variations thereof.

In some examples, a processor-executed driver for network interface device 150 can associate a single Virtual Ethernet Bridge (VEB) or switch ID with multiple physical ports. For example, the driver can configure packet processing circuitry 154 with forwarding rules 156 to route packets from ports to VFs based on logical port identifiers, as described herein. For example, one or more of processes 0 to M−1 can access a PF associated with network interface device 150 via a VF or ADI. The VF can be associated with a tenant running in a multi-tenant environment.

Host 100 and network interface device 150 can be communicatively coupled by host interface 120. Host interface 120 can provide communication using one or more of the following protocols: Improved Inter Integrated Circuit (I3C), Universal Serial Bus Type-C(USB-C), serial peripheral interface (SPI), enhanced SPI (eSPI), System Management Bus (SMBus), I2C, MIPI I3C®, Peripheral Component Interconnect Express (PCIe), Compute Express Link (CXL). See, for example, Peripheral Component Interconnect Express (PCIe) Base Specification 1.0 (2002), as well as earlier versions, later versions, and variations thereof. See, for example, Compute Express Link (CXL) Specification revision 2.0, version 0.7 (2019), as well as earlier versions, later versions, and variations thereof.

Network interface device 150 can be implemented as one or more of: a network interface controller (NIC), a remote direct memory access (RDMA)-enabled NIC, SmartNIC, router, switch, virtual switch, forwarding element, infrastructure processing unit (IPU), data processing unit (DPU), or edge processing unit (EPU). An edge processing unit (EPU) can include a network interface device that utilizes processors and accelerators (e.g., digital signal processors (DSPs), signal processors, or wireless specific accelerators for Virtualized radio access networks (vRANs), cryptographic operations, compression/decompression, and so forth).

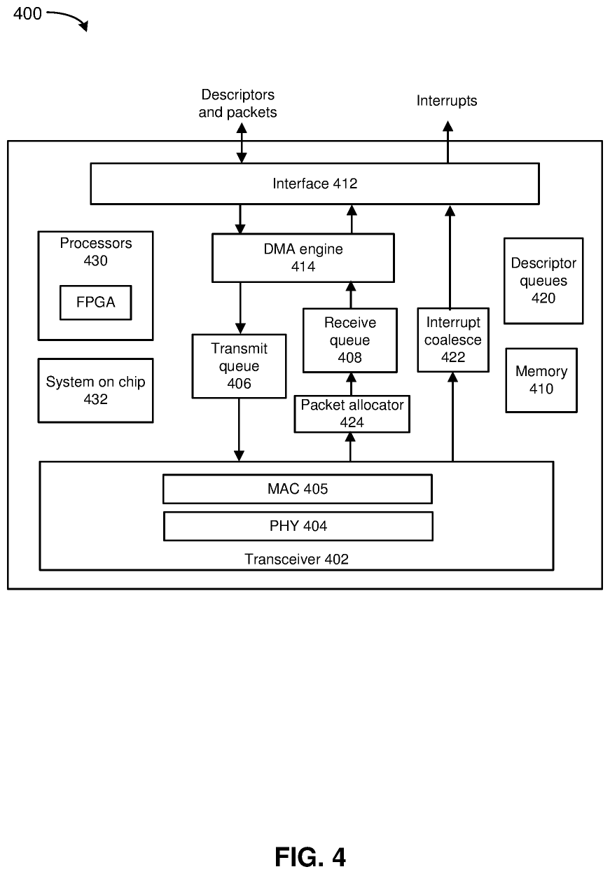

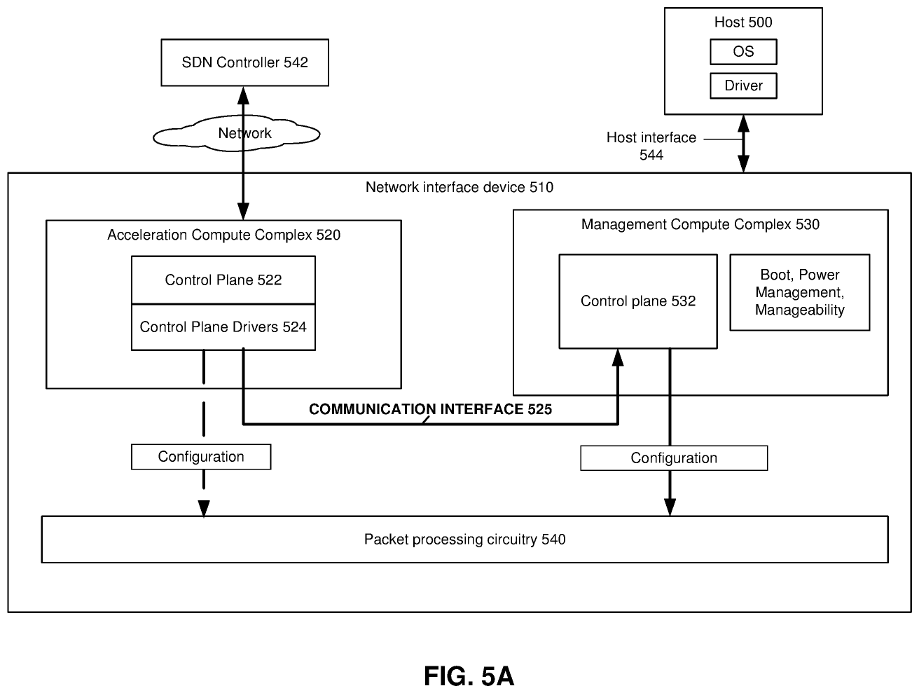

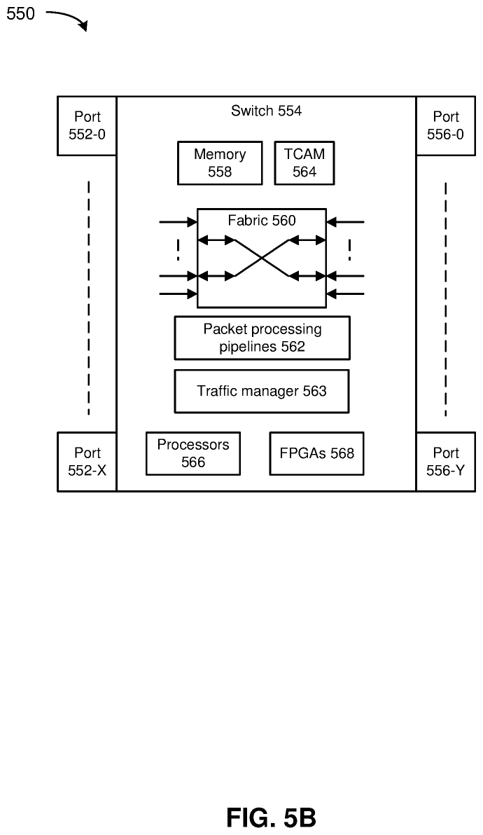

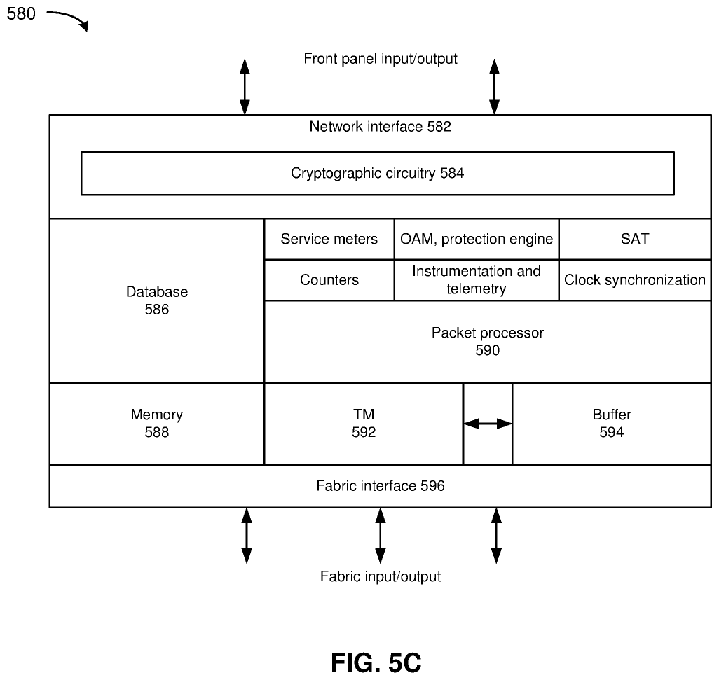

Network interface device 150 can include at least a direct memory access (DMA) circuitry 152, packet processing circuitry 154, and network interface 158, as well as other circuitry and software described with respect to FIGS. 4, 5A, 5B, 5C, and/or 6. Network interface device 150 can utilize one or more of ports 158-0 to 158-N−1 (where N is an integer) to receive packets (at ingress) or transmit packets (at egress).

In some situations, a single switch ID instance may be used to represent a single PF across logical ports. Packets received on one or more ports can be associated with a same switch ID value but targeted to different VFs and the target VF may not be determined from a single switch ID value such as where forwarding rules to a VF are based on switch ID value. Network interface device 150 can associate a packet received on a port with a logical port ID. For example, packet processing circuitry 154 can apply forwarding rules 156 to lookup a VSI list based on a logical port ID of a received packet to determine a target VF for the received packet based on the VSI list so that packets associated with a single switch ID, but received on different ports, can be routed to a correct target VF. For example, packet processing circuitry 154 can apply forwarding rules 156 so that if a packet arrives at an expected or unexpected ingress port and has a destination port of destination MAC address of a particular VF, the packet can be switched to that particular VF, to accept the packet. Accordingly, even if a destination MAC address and logical port for a packet is not associated with an ingress port for the packet, based on forwarding rules 156, packet processing circuitry 154 can forward the packet to the correct target VF. However, to reduce the likelihood of malicious attacks by packets, forwarding rules 156 can cause filtering of packets received on an unexpected ingress port when a number of packets received on an unexpected ingress port exceeds a configured level, as the packets may represent a distributed denial of service (DDoS) attack or other overload attack. In some examples, packet processing circuitry 154 can reorder packets by timestamp or sequence number if packets are received out of order on one or more ingress ports. In some examples, packet processing circuitry 154 can perform operations such as packet inspection to read packet header values or data integrity values, send alerts to management consoles based on detection of potentially malicious packet traffic, or update routing tables based on a configuration.

Various examples configure packet processing circuitry 154 with rules 156 to allow for forwarding a packet (including broadcast and multicast packets) received on port Y to a VF pinned to that port Y, prune cross port traffic, allow internal communication (including broadcast and multicast packets) between VSIs (e.g., VF-VF or VM-VM flows) irrespective of what port they are pinned to, and allows for exception path rules to a default VSI. For example, broadcast and multicast packets can be forwarded to multiple VSIs.

Packet processing circuitry 154 can be configured by rules 156 as follows. First, an accept or allow list per virtual port that includes Virtual Station Interfaces (VSIs) associated with that virtual port can be created and applied by packet processing circuitry 154. The allow list can create a prune action to drop received packet traffic for a specific logical port where VSIs are not pinned to the specific logical port. A switch can be configured to prune traffic destined to VSIs not pinned to the port on which it is received by generating pruning list per Virtual Port. Secondly, a parser configuration can be created and applied by packet processing circuitry 154 for Virtual Port lookup to perform packet forwarding to a VSI list based on the Virtual Port lookup.

A Virtual Port can be associated with an accept or prune list, which includes the VSIs and VFs associated with the Virtual Port. The accept or prune list action can be applied by packet processing circuitry 154 to ingress traffic. An action for a rule can allow progress of frames (Rx) having a logical port identifier that matches the VSI list. VSIs can include connections from the switch to entities interfacing with host 100, such as a queue set of a PCIe function or part of the queues of a PCIe function. In addition, a rule for default or exception path can be established that forwards a packet whose destination MAC does not match the Virtual Station Interfaces (VSIs) in the allow list to a default VSI, such as a particular VM.

Internal loopback (e.g., VM-VM communications) can be achieved by using a particular logical port ID. When network interface device 150 detects a loopback enable flag for a transmit (Tx) frame, network interface device 150 can send the frame back to the network interface device with the logical port set to a unique value (e.g., 31). Broadcast and multicast packets can be reflected back to one or more internal VSI so that broadcast and multicast packets can be sent to multiple VSIs.

For example, an example of operations is as follows. At (1), a packet P0 can be received on port 1 of network interface device 150 and a logical port identifier determined for packet P0 by a physical layer interface (PHY) or other circuitry of network interface device 150. At (2), based on packet rules 156 and the logical port identifier, a target VF can be determined as VF0 and the packet P0 can be forwarded or made available for access by VF0. In this case, packet P0 was expected to be received at port 1.

At (3), a packet P1 can be received on port 2 of network interface device 150 and a logical port identifier determined for packet P1 by a PHY or other circuitry of network interface device 150. At (4), based on packet rules 156 and the logical port identifier, a target VF can be determined as VF0 and the packet P1 can be forwarded or made available for access by VF0. In this case, packet P1 was expected to be received at port 1, but was received at port 2.

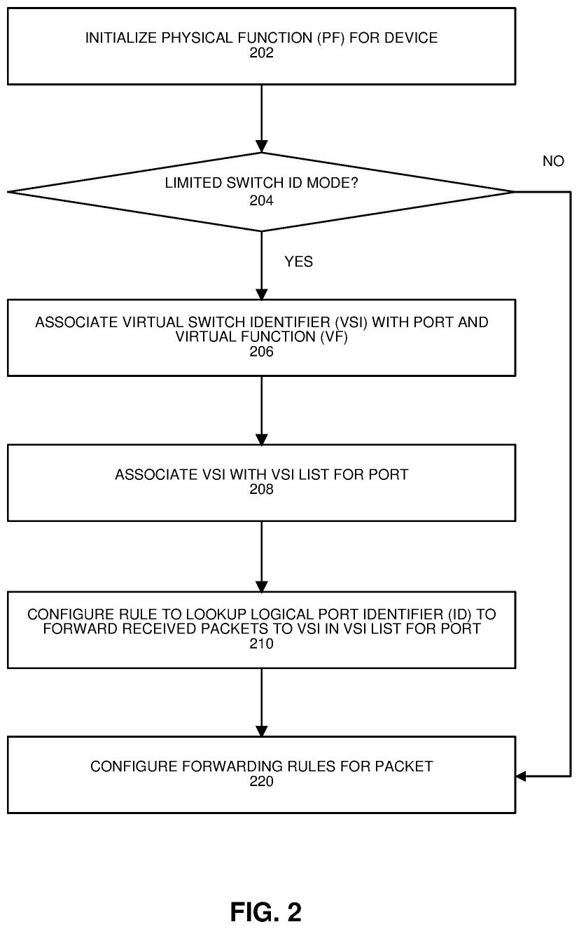

FIG. 2 depicts an example initialization process for configuring forwarding rules. The process can be performed to configure a switch or other network interface device to allow forwarding of received (Rx) packets at an ingress port to a VSI in a VSI List so that Rx packets associated with a switch ID, but received on different ports, can be routed to a correct target VF. At 202, a control plane (CP) driver executing on a processor in a host or network interface device can perform physical function (PF) initialization (init) operations. The PF initialization can be in accordance with SR-IOV or SIOV, or another virtualization specification, and can include allocating one or more VFs to the PF. At initialization, a PF can be assigned a VSI. Other VSIs can be assigned to the PF or to VFs.

At 204, a determination can be made as to whether a number of allocated switch interface IDs is less than a number of physical ports. For example, in a local area network (LAN) VF mode, a base station device provides a single switch ID to multiple ports. Based on the number of allocated switch interface IDs being less than the number of physical ports, the process can proceed to 206. Based on the number of allocated switch interface IDs being equal to or more than the number of physical ports, the process can proceed to 220.

At 206, a VSI can be associated with a port and VF. For example, a driver can assign VFs round robin to logical ports. Logical ports can be associated with physical ports. A VSI can indicate attributes for an ingress port such as function ID, switch ID, destination MAC address, queue context for the VSI, target VF, and others.

At 208, the VSI can be added to a VSI List for a port. The VSI List can be treated as an allow list for forwarding packets to or from a port. The VSI List can indicate a target VF for a logical port identifier value, destination media access control (MAC), Ethernet packet header field value, and/or virtual local area network (VLAN).

At 210, the network interface device can be configured with a rule to lookup an action for a Logical Port ID to permit forwarding of Rx packets on a port to a VSI in the VSI List. The network interface device can allow packet forwarding to a target VF if a destination VSI of a received packet is part of the VSI list for the received port. But if a destination VSI of a received packet is not part of the VSI list, then the rule can cause pruning the packet by an action of dropping the packet.

At 220, the network interface device can be configured with forwarding rules such as specifying an output port to forward a packet to based on one or more of: MAC address, VLAN, receive side scaling (RSS), protocol descriptions, or other rules. The forwarding rule can include determining a next network device hop based on destination media access control (MAC), Ethernet packet header field, virtual local area network (VLAN), and/or other header field. The network interface device can perform switching operations of a virtual switch.

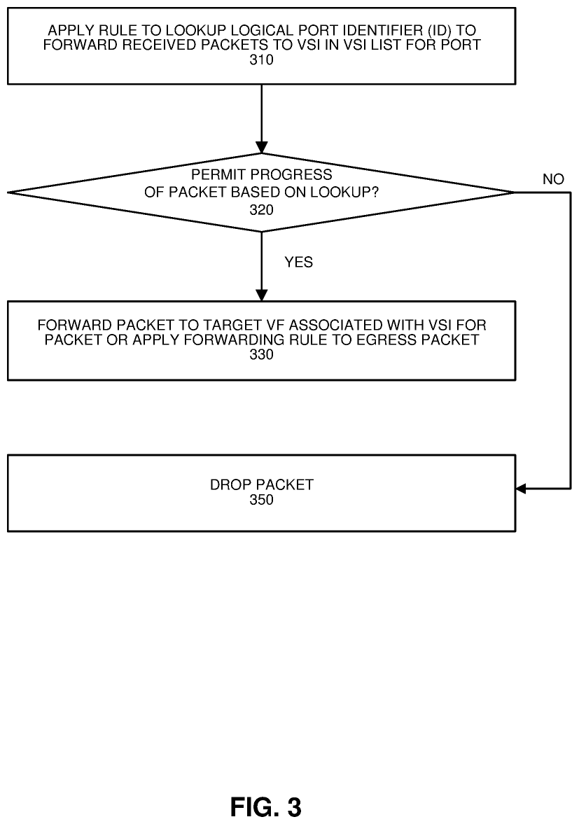

FIG. 3 depicts a process. The process can be performed by a switch or other network interface device. Based on receipt of a packet from an ingress port or a packet transmission request, at 310, the network interface device can apply a forwarding rule. At 320, a determination can be made if the forwarding rule permits progress of the packet. For example, based on the destination VSI of the packet being part of the VSI list for the received port, the process can continue to 330. Based on the destination VSI of the packet is not part of the VSI list, the process can continue to 350, where the packet can be dropped. Accept or pruning rules can apply to VF so that for a VF, rules permit forwarding of packets to that VF if a packet matches a destination MAC address but rules prune packets that that are not received from a particular port ID. So even if the packet matches based on a destination MAC address, if the packet does not match the accept or prune list (e.g., list of logical port IDs), then that packet can be dropped and not forwarded to the VF.

At 330, for a packet terminated at a host or network interface device, the packet can be forwarded to a destination VF associated with the VSI for the packet. For a packet to be egressed to another network interface device, the packet can be forwarded to a next hop. If multiple protocol specific forwarding rules are available for application by the switch, a higher priority protocol specific forwarding rule will be selected. Protocol specific rules can be applied by a parser based on Destination MAC address, VLAN, packet header fields, IP address, or other criteria.

FIG. 4 depicts an example network interface device. In some examples, processors and/or FPGAs 430 can be configured to route a packet to a target VF based on a logical port identifier (ID) of the packet irrespective of an ingress port of the packet, as described herein. Some examples of network interface 400 are part of an Infrastructure Processing Unit (IPU) or data processing unit (DPU) or utilized by an IPU or DPU. An xPU can refer at least to an IPU, DPU, graphics processing unit (GPU), general purpose GPU (GPGPU), or other processing units (e.g., accelerator devices). An IPU or DPU can include a network interface with one or more programmable circuitries or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 400 can include transceiver 402, processors 404, transmit queue 406, receive queue 408, memory 410, and bus interface 412, and DMA engine 452. Transceiver 402 can be capable of receiving and transmitting packets in conformance with the applicable protocols such as Ethernet as described in IEEE 802.3, although other protocols may be used. Transceiver 402 can receive and transmit packets from and to a network via a network medium (not depicted). Transceiver 402 can include PHY circuitry 414 and media access control (MAC) circuitry 416. PHY circuitry 414 can include encoding and decoding circuitry (not shown) to encode and decode data packets according to applicable physical layer specifications or standards. MAC circuitry 416 can be configured to perform MAC address filtering on received packets, process MAC headers of received packets by verifying data integrity, remove preambles and padding, and provide packet content for processing by higher layers. MAC circuitry 416 can be configured to assemble data to be transmitted into packets, that include destination and source addresses along with network control information and error detection hash values.

Processors 404 can be one or more of: combination of: a processor, core, graphics processing unit (GPU), field programmable gate array (FPGA), application specific integrated circuit (ASIC), or other programmable hardware device that allow programming of network interface 400. For example, a “smart network interface” or SmartNIC can provide packet processing capabilities in the network interface using processors 404.

Processors 404 can include a programmable processing pipeline or offload circuitries that is programmable by P4, Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), eBPF, x86 compatible executable binaries or other executable binaries. A programmable processing pipeline can include one or more match-action units (MAUs) that are configured based on a programmable pipeline language instruction set. Processors, FPGAs, other specialized processors, controllers, devices, and/or circuits can be used utilized for packet processing or packet modification. Ternary content-addressable memory (TCAM) can be used for parallel match-action or look-up operations on packet header content. Processors 404 can be configured to determine target VF based on a logical port identifier (ID) of a received packet and switch ID where received packets of different input ports share a same switch ID, as described herein.

Packet allocator 424 can provide distribution of received packets for processing by multiple CPUs or cores using receive side scaling (RSS). When packet allocator 424 uses RSS, packet allocator 424 can calculate a hash or make another determination based on contents of a received packet to determine which CPU or core is to process a packet.

Interrupt coalesce 422 can perform interrupt moderation whereby interrupt coalesce 422 waits for multiple packets to arrive, or for a time-out to expire, before generating an interrupt to host system to process received packet(s). Receive Segment Coalescing (RSC) can be performed by network interface 400 whereby portions of incoming packets are combined into segments of a packet. Network interface 400 provides this coalesced packet to an application.

Direct memory access (DMA) engine 452 can copy a packet header, packet payload, and/or descriptor directly from host memory to the network interface or vice versa, instead of copying the packet to an intermediate buffer at the host and then using another copy operation from the intermediate buffer to the destination buffer.

Memory 410 can be volatile and/or non-volatile memory device and can store any queue or instructions used to program network interface 400. Transmit traffic manager can schedule transmission of packets from transmit queue 406. Transmit queue 406 can include data or references to data for transmission by network interface. Receive queue 408 can include data or references to data that was received by network interface from a network. Descriptor queues 420 can include descriptors that reference data or packets in transmit queue 406 or receive queue 408. Bus interface 412 can provide an interface with host device (not depicted). For example, bus interface 412 can be compatible with or based at least in part on PCI, PCIe, PCI-x, Serial ATA, and/or USB (although other interconnection standards may be used), or proprietary variations thereof.

FIG. 5A depicts an example network interface device. Host 500 can include processors, memory devices, device interfaces, as well as other circuitry, such as those described herein. Processors of host 500 can execute software such as applications (e.g., microservices, virtual machine (VMs), microVMs, containers, processes, threads, or other virtualized execution environments), operating system (OS), and device drivers. An OS or device driver can configure network interface device or packet processing device 510 to utilize one or more control planes to communicate with software defined networking (SDN) controller 550 via a network to configure operation of the one or more control planes.

Packet processing device 510 can include multiple compute complexes, such as an Acceleration Compute Complex (ACC) 520 and Management Compute Complex (MCC) 530, as well as packet processing circuitry 540 and network interface technologies for communication with other devices via a network. ACC 520 can be implemented as one or more of: a microprocessor, processor, accelerator, field programmable gate array (FPGA), application specific integrated circuit (ASIC) or circuitry described at least with respect to herein. Similarly, MCC 530 can be implemented as one or more of: a microprocessor, processor, accelerator, field programmable gate array (FPGA), application specific integrated circuit (ASIC) or circuitry described herein. In some examples, ACC 520 and MCC 530 can be implemented as separate cores in a CPU, different cores in different CPUs, different processors in a same integrated circuit, different processors in different integrated circuit.

Packet processing device 510 can be implemented as one or more of: a microprocessor, processor, accelerator, field programmable gate array (FPGA), application specific integrated circuit (ASIC) or circuitry described herein. Packet processing circuitry 540 can process packets as directed or configured by one or more control planes executed by multiple compute complexes. In some examples, ACC 520 and MCC 530 can execute respective control planes 522 and 532.

Packet processing device 510, ACC 520, and/or MCC 530 can be configured to route a packet to a target VF based on a logical port identifier (ID) of the packet irrespective of an ingress port of the packet, as described herein.

SDN controller 542 can upgrade or reconfigure software executing on ACC 520 (e.g., control plane 522 and/or control plane 532) through contents of packets received through packet processing device 510. In some examples, ACC 520 can execute control plane operating system (OS) (e.g., Linux) and/or a control plane application 522 (e.g., user space or kernel modules) used by SDN controller 542 to configure operation of packet processing circuitry 540. Control plane application 522 can incude Generic Flow Tables (GFT), ESXi, NSX, Kubernetes control plane software, application software for managing crypto configurations, Programming Protocol-independent Packet Processors (P4) runtime daemon, target specific daemon, Container Storage Interface (CSI) agents, or remote direct memory access (RDMA) configuration agents.

In some examples, SDN controller 542 can communicate with ACC 520 using a remote procedure call (RPC) such as Google remote procedure call (gRPC) or other service and ACC 520 can convert the request to target specific protocol buffer (protobuf) request to MCC 530. gRPC is a remote procedure call solution based on data packets sent between a client and a server. Although gRPC is an example, other communication schemes can be used such as, but not limited to, Java Remote Method Invocation, Modula-3, RPyC, Distributed Ruby, Erlang, Elixir, Action Message Format, Remote Function Call, Open Network Computing RPC, JSON-RPC, and so forth.

In some examples, SDN controller 542 can provide packet processing rules for performance by ACC 520. For example, ACC 520 can program table rules (e.g., header field match and corresponding action) applied by packet processing circuitry 540 based on change in policy and changes in VMs, containers, microservices, applications, or other processes. ACC 520 can be configured to provide network policy as flow cache rules into a table to configure operation of packet processing 540. For example, the ACC-executed control plane application 522 can configure rule tables applied by packet processing circuitry 540 with rules to define a traffic destination based on packet type and content. ACC 520 can program table rules (e.g., match-action) into memory accessible to packet processing circuitry 540 based on change in policy and changes in VMs.

For example, ACC 520 can execute a virtual switch such as vSwitch or Open vSwitch (OVS), Stratum, or Vector Packet Processing (VPP) that provides communications between virtual machines executed by host 500 or with other devices connected to a network. For example, ACC 520 can configure packet processing circuitry 540 as to which VM is to receive traffic and what kind of traffic a VM can transmit. For example, packet processing circuitry 540 can execute a virtual switch such as vSwitch or Open vSwitch that provides communications between virtual machines executed by host 500 and packet processing device 510.

MCC 530 can execute a host management control plane, global resource manager, and perform hardware registers configuration. Control plane 532 executed by MCC 530 can perform provisioning and configuration of packet processing circuitry 540. For example, a VM executing on host 500 can utilize packet processing device 510 to receive or transmit packet traffic. MCC 530 can execute boot, power, management, and manageability software (SW) or firmware (FW) code to boot and initialize the packet processing device 510, manage the device power consumption, provide connectivity to Baseboard Management Controller (BMC), and other operations.

One or both control planes of ACC 520 and MCC 530 can define traffic routing table content and network topology applied by packet processing circuitry 540 to select a path of a packet in a network to a next hop or to a destination network-connected device. For example, a VM executing on host 500 can utilize packet processing device 510 to receive or transmit packet traffic.

ACC 520 can execute control plane drivers to communicate with MCC 530. At least to provide a configuration and provisioning interface between control planes 522 and 532, communication interface 525 can provide control-plane-to-control plane communications. Control plane 532 can perform a gatekeeper operation for configuration of shared resources. For example, via communication interface 525, ACC control plane 522 can communicate with control plane 532 to perform one or more of: determine hardware capabilities, access the data plane configuration, reserve hardware resources and configuration, communications between ACC and MCC through interrupts or polling, subscription to receive hardware events, perform indirect hardware registers read write for debuggability, flash and physical layer interface (PHY) configuration, or perform system provisioning for different deployments of network interface device such as: storage node, tenant hosting node, microservices backend, compute node, or others.

Communication interface 525 can be utilized by a negotiation protocol and configuration protocol running between ACC control plane 522 and MCC control plane 532. Communication interface 525 can include a general purpose mailbox for different operations performed by packet processing circuitry 540. Examples of operations of packet processing circuitry 540 include issuance of non-volatile memory express (NVMe) reads or writes, issuance of Non-volatile Memory Express over Fabrics (NVMe-oF™) reads or writes, lookaside crypto Engine (LCE) (e.g., compression or decompression), Address Translation Engine (ATE) (e.g., input output memory management unit (IOMMU) to provide virtual-to-physical address translation), encryption or decryption, configuration as a storage node, configuration as a tenant hosting node, configuration as a compute node, provide multiple different types of services between different Peripheral Component Interconnect Express (PCIe) end points, or others.

Communication interface 525 can include one or more mailboxes accessible as registers or memory addresses. For communications from control plane 522 to control plane 532, communications can be written to the one or more mailboxes by control plane drivers 524. For communications from control plane 532 to control plane 522, communications can be written to the one or more mailboxes. Communications written to mailboxes can include descriptors which include message opcode, message error, message parameters, and other information. Communications written to mailboxes can include defined format messages that convey data.

Communication interface 525 can provide communications based on writes or reads to particular memory addresses (e.g., dynamic random access memory (DRAM)), registers, other mailbox that is written-to and read-from to pass commands and data. To provide for secure communications between control planes 522 and 532, registers and memory addresses (and memory address translations) for communications can be available only to be written to or read from by control planes 522 and 532 or cloud service provider (CSP) software executing on ACC 520 and device vendor software, embedded software, or firmware executing on MCC 530. Communication interface 525 can support communications between multiple different compute complexes such as from host 500 to MCC 530, host 500 to ACC 520, MCC 530 to ACC 520, baseboard management controller (BMC) to MCC 530, BMC to ACC 520, or BMC to host 500.

Packet processing circuitry 540 can be implemented using one or more of: application specific integrated circuit (ASIC), field programmable gate array (FPGA), processors executing software, or other circuitry. Control plane 522 and/or 532 can configure packet processing circuitry 540 or other processors to perform operations related to NVMe, NVMe-oF reads or writes, lookaside crypto Engine (LCE), Address Translation Engine (ATE), local area network (LAN), compression/decompression, encryption/decryption, or other accelerated operations.

Various message formats can be used to configure ACC 520 or MCC 530. In some examples, a P4 program can be compiled and provided to MCC 530 to configure packet processing circuitry 540.

FIG. 5B depicts an example switch. Various examples can be used in or with the switch to route a packet to a target VF based on a logical port identifier (ID) of the packet irrespective of an ingress port of the packet, as described herein. Switch 554 can route packets or frames of any format or in accordance with any specification from any port 552-0 to 552-X to any of ports 556-0 to 556-Y (or vice versa). One or more of ports 552-0 to 552-X can be connected to a network of one or more interconnected devices. Similarly, any of ports 556-0 to 556-Y can be connected to a network of one or more interconnected devices.

In some examples, switch fabric 560 can provide routing of packets from one or more ingress ports for processing prior to egress from switch 554. Switch fabric 560 can be implemented as one or more multi-hop topologies, where example topologies include torus, butterflies, buffered multi-stage, etc., or shared memory switch fabric (SMSF), among other implementations. SMSF can be any switch fabric connected to ingress ports and egress ports in the switch, where ingress subsystems write (store) packet segments into the fabric's memory, while the egress subsystems read (fetch) packet segments from the fabric's memory.

Memory 558 can be configured to store packets received at ports prior to egress from one or more ports. Packet processing circuitry 562 can include ingress and egress packet processing circuitry to respectively process ingressed packets and packets to be egressed. Packet processing circuitry 562 can determine which port to transfer packets or frames to using a table that maps packet characteristics with an associated output port. Packet processing circuitry 562 can be configured to perform match-action on received packets to identify packet processing rules and next hops using information stored in a ternary content-addressable memory (TCAM) tables or exact match tables in some examples. For example, match-action tables or circuitry can be used whereby a hash of a portion of a packet is used as an index to find an entry (e.g., forwarding decision based on a packet header content). Packet processing circuitry 562 can implement access control list (ACL) or packet drops due to queue overflow. Packet processing circuitry 562 can be configured to determine target VF based on a logical port identifier (ID) of a received packet and switch ID where received packets of different input ports share a same switch ID, as described herein. Configuration of operation of packet processing circuitry 562, including its data plane, can be programmed using P4, C, Python, Broadcom Network Programming Language (NPL), or x86 compatible executable binaries or other executable binaries. Processors 566 and FPGAs 568 can be utilized for packet processing or modification.

Traffic manager 563 can perform hierarchical scheduling and transmit rate shaping and metering of packet transmissions from one or more packet queues. Traffic manager 563 can perform congestion management such as flow control, congestion notification message (CNM) generation and reception, priority flow control (PFC), and others.

FIG. 5C depicts an example switch. Various examples can be used in or with the switch to provide a packet to a target VF based on a logical port identifier (ID) of the packet irrespective of an ingress port of the packet, as described herein. Switch 580 can include a network interface 582 that can provide an Ethernet consistent interface. Network interface 582 can support 25 GbE, 50 GbE, 100 GbE, 200 GbE, 400 GbE Ethernet port interfaces. Cryptographic circuitry 584 can perform at least Media Access Control security (MACsec) or Internet Protocol Security (IPSec) decryption for received packets or encryption for packets to be transmitted.

Various circuitry can perform one or more of: service metering, packet counting, operations, administration, and management (OAM), protection engine, instrumentation and telemetry, and clock synchronization (e.g., based on IEEE 1588).

Database 586 can store a device's profile to configure operations of switch 580. Memory 588 can include High Bandwidth Memory (HBM) for packet buffering. Packet processor 590 can perform one or more of: decision of next hop in connection with packet forwarding, packet counting, access-list operations, bridging, routing, Multiprotocol Label Switching (MPLS), virtual private LAN service (VPLS), L2VPNs, L3VPNs, OAM, Data Center Tunneling Encapsulations (e.g., VXLAN and NV-GRE), or others. Packet processor 590 can include one or more FPGAs. Buffer 594 can store one or more packets. Traffic Manager™ 592 can provide per-subscriber bandwidth guarantees in accordance with service level agreements (SLAs) as well as performing hierarchical quality of service (QoS). Fabric interface 596 can include a serializer/de-serializer (SerDes) and provide an interface to a switch fabric.

Operations of components of switches of examples of devices described herein can be combined and components of the switches described herein can be included in other examples of switches of examples described herein. For example, components of examples of switches described herein can be implemented in a switch system on chip (SoC) that includes at least one interface to other circuitry in a switch system. A switch SoC can be coupled to other devices in a switch system such as ingress or egress ports, memory devices, or host interface circuitry.

FIG. 6 depicts a system. In some examples, circuitry of system 600 can configure network interface device 650 to route a packet to a target VF based on a logical port identifier (ID) of the packet irrespective of an ingress port of the packet, as described herein. In some examples, circuitry of network interface device 650 can be utilized to determine target VF based on a logical port identifier (ID) of a received packet and switch ID where received packets of different input ports share a same switch ID, as described herein. System 600 includes processor 610, which provides processing, operation management, and execution of instructions for system 600. Processor 610 can include any type of microprocessor, central processing unit (CPU), graphics processing unit (GPU), XPU, processing core, or other processing hardware to provide processing for system 600, or a combination of processors. An XPU can include one or more of: a CPU, a graphics processing unit (GPU), general purpose GPU (GPGPU), and/or other processing units (e.g., accelerators or programmable or fixed function FPGAs). Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 600 includes interface 612 coupled to processor 610, which can represent a higher speed interface or a high throughput interface for system components that needs higher bandwidth connections, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610. For example, an accelerator among accelerators 642 can provide data compression (DC) capability, cryptography services such as public key encryption (PKE), cipher, hash/authentication capabilities, decryption, or other capabilities or services. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the Al model can use or include any or a combination of: a reinforcement learning scheme, Q-learning scheme, deep-Q learning, or Asynchronous Advantage Actor-Critic (A3C), combinatorial neural network, recurrent combinatorial neural network, or other Al or ML model. Multiple neural networks, processor cores, or graphics processing units can be made available for use by Al or ML models to perform learning and/or inference operations.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

Applications 634 and/or processes 636 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 632 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

In some examples, OS 632, a system administrator, and/or orchestrator can configure network interface 650 to determine target VF based on a logical port identifier (ID) of a received packet and switch ID where received packets of different input ports share a same switch ID, as described herein.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory. In some examples, packet processing device or network interface device 650 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described herein.

In one example, system 600 includes one or more input/output (I/O) interface(s) 660. I/O interface 660 can include one or more interface components through which a user interacts with system 600. Peripheral interface 670 can include any hardware interface not specifically mentioned above. Peripherals refer generally to devices that connect dependently to system 600.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 600 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 600 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.′”

Illustrative examples of the devices, systems, and methods disclosed herein are provided below. An embodiment of the devices, systems, and methods may include any one or more, and any combination of, the examples described below.

Example 1 includes one or more examples and an apparatus comprising: a switch circuitry comprising: an interface to a first ingress port; an interface to a second ingress port; and circuitry to: associate the first ingress port with a first virtual function (VF); associate the second ingress port with a second VF; and based on a configuration and receipt of a first packet at the first ingress port, cause the first packet to be filtered, wherein the first packet is addressed to the second VF.

Example 2 includes one or more examples, wherein the circuitry is to: based on the configuration and a destination media access control (MAC) address and logical port identifier (ID) of the first ingress port being associated with receipt of a second packet, cause the second packet to be provided to the first VF.

Example 3 includes one or more examples, wherein the switch circuitry comprises a second circuitry to determine the logical port ID of the second packet based on receipt at the first ingress port.

Example 4 includes one or more examples, wherein the circuitry is to: based on receipt of a third packet at a third ingress port and based on the configuration and a destination media access control (MAC) address and logical port identifier of the third ingress port being associated with the third packet, drop the third packet.

Example 5 includes one or more examples, and includes a network interface device that comprises the switch circuitry, wherein the network interface device comprises one or more of: a network interface controller (NIC), a remote direct memory access (RDMA)-enabled NIC, SmartNIC, router, virtual switch, forwarding element, infrastructure processing unit (IPU), data processing unit (DPU), or edge processing unit (EPU).

Example 6 includes one or more examples, wherein the configuration comprises a packet accept list based on one or more of: Virtual Station Interfaces (VSIs), a virtual port, destination media access control (MAC), and/or logical port identifier (ID).

Example 7 includes one or more examples, wherein the switch circuitry is associated with a single switch identifier (ID) and the switch circuitry is associated with multiple VFs.

Example 8 includes one or more examples, wherein the switch circuitry is to cause transmission of packets, that share a same switch ID, from different egress ports.

Example 9 includes one or more examples, wherein the first VF is associated with a first process and a first tenant in a multi-tenant environment.

Example 10 includes one or more examples, wherein the switch circuitry is to: determine a next hop for the first packet.

Example 11 includes one or more examples, and includes at least one non-transitory computer-readable medium comprising instructions stored thereon, that if executed by a switch circuitry, cause the switch circuitry to: based on receipt of a first packet at a first ingress port and a configuration, cause the first received packet to be provided to a first target virtual function (VF) and based on receipt of a second packet at a second ingress port and the configuration, cause the second received packet to be provided to the first target VF, wherein the second received packet is to be received at the first ingress port but was received at the second ingress port.

Example 12 includes one or more examples, wherein the cause the second received packet to be provided to the first target VF comprises: based on the configuration and a destination media access control (MAC) address and logical port identifier of the first ingress port associated with the second received packet, cause the second received packet to be provided to the first target VF.

Example 13 includes one or more examples, comprising instructions stored thereon, that if executed by a processor, cause the processor to: based on receipt of a third packet at a third ingress port and based on the configuration and a destination media access control (MAC) address and logical port identifier of the third ingress port associated with the third packet, drop the third packet.

Example 14 includes one or more examples, wherein the configuration comprises a packet accept list based on one or more of: Virtual Station Interfaces (VSIs), a virtual port, destination media access control (MAC), and/or logical port identifier (ID).

Example 15 includes one or more examples, wherein the switch circuitry is associated with a single switch identifier (ID) and the switch circuitry is associated with multiple VFs.

Example 16 includes one or more examples, and includes a method that includes: a switch performing: based on receipt of a first packet at a first ingress port and a configuration, causing the first received packet to be provided to a first target virtual function (VF) and based on receipt of a second packet at a second ingress port and the configuration, causing the second received packet to be provided to the first target VF, wherein the second received packet is to be received at the first ingress port but was received at the second ingress port.

Example 17 includes one or more examples, wherein the causing the second received packet to be provided to the first target VF comprises: based on the configuration and a destination media access control (MAC) address and logical port identifier of the first ingress port associated with the second received packet, causing the second received packet to be provided to the first target VF.

Example 18 includes one or more examples, and includes based on receipt of a third packet at a third ingress port and based on the configuration and a destination media access control (MAC) address and logical port identifier of the third ingress port associated with the third packet, drop the third packet.

Example 19 includes one or more examples, wherein the configuration comprises a packet accept list based on one or more of: Virtual Station Interfaces (VSIs), a virtual port, destination media access control (MAC), and/or logical port identifier (ID).

Example 20 includes one or more examples, wherein the switch is associated with a single switch identifier (ID) and the switch is associated with multiple VFs.

1. An apparatus comprising:
a switch circuitry comprising:
an interface to a first ingress port;
an interface to a second ingress port; and
circuitry to:
associate the first ingress port with a first virtual function (VF);
associate the second ingress port with a second VF; and
based on a configuration and receipt of a first packet at the first ingress port, cause the first packet to be filtered, wherein the first packet is addressed to the second VF.

2. The apparatus of claim 1, wherein the circuitry is to:
based on the configuration and a destination media access control (MAC) address and logical port identifier (ID) of the first ingress port being associated with receipt of a second packet, cause the second packet to be provided to the first VF.

3. The apparatus of claim 2, wherein:
the switch circuitry comprises a second circuitry to determine the logical port ID of the second packet based on receipt at the first ingress port.

4. The apparatus of claim 1, wherein the circuitry is to:
based on receipt of a third packet at a third ingress port and based on the configuration and a destination media access control (MAC) address and logical port identifier of the third ingress port being associated with the third packet, drop the third packet.

5. The apparatus of claim 1, comprising a network interface device that comprises the switch circuitry, wherein the network interface device comprises one or more of: a network interface controller (NIC), a remote direct memory access (RDMA)-enabled NIC, SmartNIC, router, virtual switch, forwarding element, infrastructure processing unit (IPU), data processing unit (DPU), or edge processing unit (EPU).

6. The apparatus of claim 1, wherein the configuration comprises a packet accept list based on one or more of: Virtual Station Interfaces (VSIs), a virtual port, destination media access control (MAC), and/or logical port identifier (ID).

7. The apparatus of claim 1, wherein the switch circuitry is associated with a single switch identifier (ID) and the switch circuitry is associated with multiple VFs.

8. The apparatus of claim 1, wherein:
the switch circuitry is to cause transmission of packets, that share a same switch ID, from different egress ports.

9. The apparatus of claim 1, wherein the first VF is associated with a first process and a first tenant in a multi-tenant environment.

10. The apparatus of claim 1, wherein the switch circuitry is to:
determine a next hop for the first packet.

11. At least one non-transitory computer-readable medium comprising instructions stored thereon, that if executed by a switch circuitry, cause the switch circuitry to:
based on receipt of a first packet at a first ingress port and a configuration, cause the first received packet to be provided to a first target virtual function (VF) and
based on receipt of a second packet at a second ingress port and the configuration, cause the second received packet to be provided to the first target VF, wherein the second received packet is to be received at the first ingress port but was received at the second ingress port.

12. The at least one non-transitory computer-readable medium of claim 11, wherein the cause the second received packet to be provided to the first target VF comprises:
based on the configuration and a destination media access control (MAC) address and logical port identifier of the first ingress port associated with the second received packet, cause the second received packet to be provided to the first target VF.

13. The at least one non-transitory computer-readable medium of claim 11, comprising instructions stored thereon, that if executed by a processor, cause the processor to:
based on receipt of a third packet at a third ingress port and based on the configuration and a destination media access control (MAC) address and logical port identifier of the third ingress port associated with the third packet, drop the third packet.

14. The at least one non-transitory computer-readable medium of claim 11, wherein the configuration comprises a packet accept list based on one or more of: Virtual Station Interfaces (VSIs), a virtual port, destination media access control (MAC), and/or logical port identifier (ID).

15. The at least one non-transitory computer-readable medium of claim 11, wherein the switch circuitry is associated with a single switch identifier (ID) and the switch circuitry is associated with multiple VFs.

16. A method comprising:
a switch performing:
based on receipt of a first packet at a first ingress port and a configuration, causing the first received packet to be provided to a first target virtual function (VF) and
based on receipt of a second packet at a second ingress port and the configuration, causing the second received packet to be provided to the first target VF, wherein the second received packet is to be received at the first ingress port but was received at the second ingress port.

17. The method of claim 16, wherein the causing the second received packet to be provided to the first target VF comprises:
based on the configuration and a destination media access control (MAC) address and logical port identifier of the first ingress port associated with the second received packet, causing the second received packet to be provided to the first target VF.

18. The method of claim 16, comprising:
based on receipt of a third packet at a third ingress port and based on the configuration and a destination media access control (MAC) address and logical port identifier of the third ingress port associated with the third packet, drop the third packet.

19. The method of claim 16, wherein the configuration comprises a packet accept list based on one or more of: Virtual Station Interfaces (VSIs), a virtual port, destination media access control (MAC), and/or logical port identifier (ID).

20. The method of claim 16, wherein the switch is associated with a single switch identifier (ID) and the switch is associated with multiple VFs.
